(19) United States
(12) Patent Application Publication
(10) Pub. No.: US 2013/0282410 A1
(43) Pub. Date: Oct. 24, 2013

(54) HAZARD RISK ASSESSMENT

(71) Applicant: Kelly Roy Petersen, Hanna City, IL (US)

(72) Inventor: Kelly Roy Petersen, Hanna City, IL (US)

(21) Appl. No.: 13/866,734

(22) Filed: Apr. 19, 2013

Related U.S. Application Data
(60) Provisional application No. 61/635,505, filed on Apr. 19, 2012.

(51) Int. Cl. G06Q 10/06; G06Q 40/08

(52) U.S. Cl. CPC G06Q 10/0635; G06Q 40/08
USPC 705/4

(57) ABSTRACT

A method and apparatus prompt for input of and receiving hazards of a workplace, prompt for input of an receiving an exposure frequency value for each received hazard, prompt for input of an receiving an outcome severity value for each received hazard, and prompt for input of an receiving an occurrence probability value for each identified hazard. A risk-based score for each identified hazard is determined based on the exposure frequency value, the outcome severity value and the occurrence probability value of each of the identified hazards of the workplace.

### CROSS-REFERENCE TO RELATED PATENT APPLICATIONS

The present application claims priority under 35 USC 119(e) from co-pending US Provisional Patent Application Ser. No. 61/635,505 filed on Apr. 19, 2012 by Kelly Roy Petersen, Sr. and entitled METHODOLOGY AND SYSTEM FOR RISK, SAFETY AND ENVIRONMENTAL MANAGEMENT, CRISIS MANAGEMENT AND PREDITIVE MODELING, the full disclosure of which is hereby incorporated by reference.

### BACKGROUND

Hazards or dangerous conditions may be found in various workplace and other environments, subjecting a company, employee or other entity to risk. Such risks are frequently insured. Insurance premiums are typically based upon historical data. Unfortunately, historical data may lack sufficient reliability or accuracy, resulting in an incorrect assessment of an ongoing risk, improper insurance premiums and inadequate risk precautions.

### BRIEF DESCRIPTION OF THE DRAWINGS

FIG. 1 is a schematic illustration of an example risk assessment system.

FIG. 2 is a flow diagram of an example method that may be carried out by the risk assessment system of FIG. 1.

FIG. 3 is a diagram of an example matrix for assignment of exposure frequency, outcome severity an occurrence probability values.

FIG. 4 is an example display output that may be presented by the system of FIG. 1.

FIG. 5 is an example method that may be carried out by the system of FIG. 1.

FIG. 6 is an example method for determining a cost multiplier that may be carried out by the system of FIG. 1.

FIG. 7 is an example output display that may be presented by the system of FIG. 1.

FIGS. 8a-8c are example output displays that may be presented by the system of FIG. 1.

### DETAILED DESCRIPTION OF THE EXAMPLE EMBODIMENTS

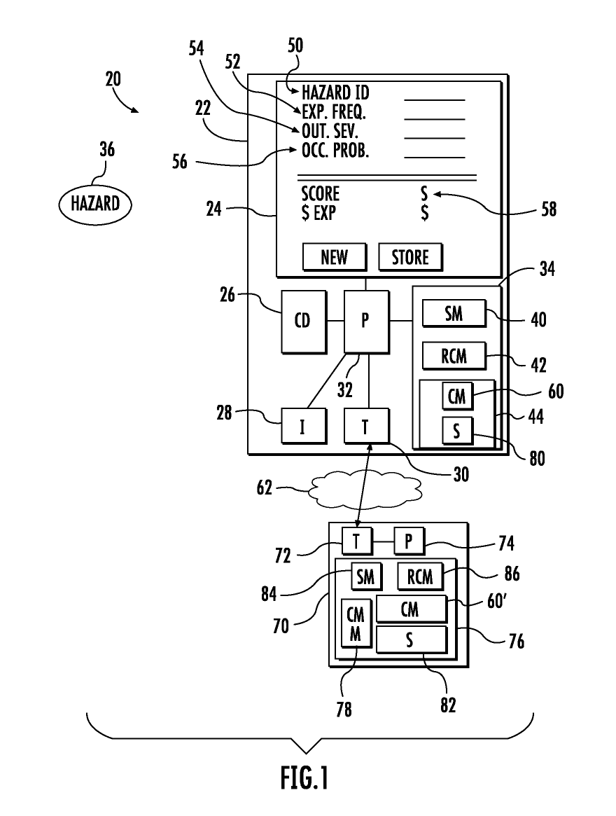

FIG. 1 schematically illustrates an example risk assessment system 20. As will be described hereafter, in contrast to traditional risk assessment systems, system 20 assesses risk predictively. As a result, system 20 facilitates improved assessment of ongoing risks, appropriate assignment of insurance premiums and appropriate safety precautions.

Risk assessment system 20 comprises electronic device 22. In one implementation, electronic device 22 comprises a portable electronic device such as a smart phone, computing notebook, computing tablet, computing laptop by the like. Because electronic device 22 is portable, electronic device 22 may be portably carried to a workplace or other site being inspected or assessed for risk or safety concerns. In other implementations, electronic device 22 may be more stationary in nature, wherein data collected from a workplace or site being inspected or assessed is entered into system 22 remote from the workplace or site being inspected.

Electronic device 22 comprises display 24, capture device 26, input 28, transceiver 30, processor 32 and memory 34. Display 24 comprise a screen, monitor or the like by which command and/or data requests or prompts are made and by which data or information results are presented. In one implementation, display 24 facilitate selections by providing one or more graphical user interfaces that are manually selected by touch such as where display 24 comprises a touch screen. In other implementations, display 24 may facilitate selections by providing one or more graphical user interfaces chosen by a cursor or the like.

Capture device 26 comprises a device to capture an image of a hazard 36 that is identified. In one implementation, capture device 26 comprises a camera, such as a still camera or a video camera. Capture device 26 facilitates the capture of an image of an identified hazard 36, wherein electronic device 22 stores the captured image either in memory 34 or remotely, wherein the stored captured image is linked to the data input for the identified hazard 36 as well as the score or exposure cost determined for the identified hazard 36. In some implementations, capture device 26 may be omitted.

Input 28 comprises one or more devices by which data and command selections may be entered. In one implementation, input 28 comprises a mouse. In another implementation, input 28 may comprise other forms of input such as a stylus, microphone with associated speech recognition software, a touchpad, a keypad, keyboard and the like. In some implementations, input 28 may be incorporated as part of display 24 such as where display 24 comprise a touch screen.

Transceiver 30 comprises a device by which electronic device 22 communicates to remote computing devices such as remote servers or websites. In one implementation, transceiver 30 facilitates wireless communication through one or more local area networks or wide area networks. Examples of such a wide area network include a phone network and/or the Internet. In another implementation, transceiver 30 may facilitate wired communication. In some implementations, transceiver 30 may be omitted.

Processor 32 comprise one or more processing units configured to generate control signals based upon instructions provided in memory 34. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, portions of processor 32 and memory 34 may be embodied as part of one or more application-specific integrated circuits (ASICs). Unless otherwise specifically noted, the controller is not limited to any specific combination of hardware circuitry and software, nor to any particular source for the instructions executed by the processing unit.

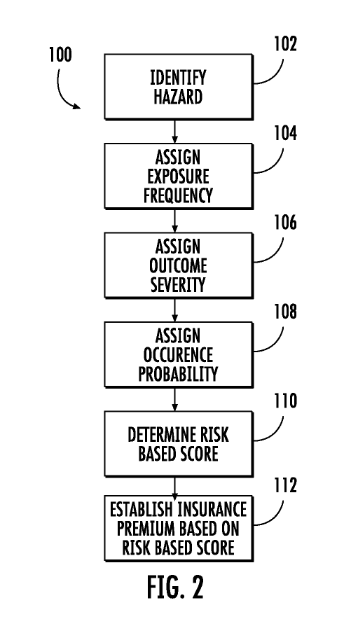

Memory 34 comprises a non-transient or non-transitory computer-readable medium or persistent storage device for storing data and computer-readable, executable programming. Memory 34 comprises scoring module 40, risk cost module 42 and data storage 44. Scoring module 40 comprises a set or group of computer-readable instructions, code or software configured to direct processor 32 to carry out the example method 100 outlined in FIG. 2. As indicated by step 102 of FIG. 2, scoring module 40 directs processor 32 to generate control signals prompting the input of a hazard identification. As shown in the example screen on display 24 and FIG. 1, scoring module 40 directs processor 32 to generate control signals causing a hazard ID prompt 50 to be presented. In response to the prompt, a risk assessor is asked to identify the hazard. A hazard is any condition at a workplace or other site being assessed that has an associated risk or safety concern. For example, a hazard may be the failure to follow safety precautions such as a worker failing to wear safety glasses in an area where grinding occurs and where sparks may be present. A hazard may be the presence of dust or exhaust which may create health concerns. A hazard may be the operation of a machine lacking shields or guards. A hazard may be a job requirement that a person lift a certain amount of weight, presenting the risk of back injury. A hazard may be a spill on a floor creating the risk of slipping. Hazard may be a person sitting for an extended period of time or perform prolonged periods of typing on a keyboard, presenting the risk of muscle fatigue, stiffness, carpal tunnel and the like.

In one implementation, score module 40 causes processor 32 to prompt the risks us to categorize the hazard as part of entering the hazard identification at prompt 50. For example, the risk assessor may be asked to enter one of a plurality of predefined hazard identification numbers or codes assigned to different categories of hazards. The hazard identification is entered using input 28.

As indicated by step 104, scoring module 40 directs processor 32 to further generate control signals causing display 24 to present an exposure frequency prompt 52. Exposure frequency prompt 52 requests that the risk assessor enter in or assign a value representing a frequency at which exposure to the hazard or risk occurs. For example, a hazard may be the result of a worker not wearing safety glasses in the presence of a grinder which emits sparks. The exposure frequency assigned to the hazard may vary depending upon the present of time that the grinder emits sparks and the number of times that the worker not wearing safety glasses is in close proximity to the grinder. In one implementation, the risk assessor may be prompted to enter the number of times that a person is exposed to the hazard or risk in a given predefined period of time. In another implementation, the risk assessor may be prompted to enter an index value, grade or other value associated with a range of frequencies for exposure to the risk or hazard.

As indicated by step 106, scoring module 40 further directs processor 30 to generate control signals causing display 24 to present an output severity prompt 54. Output severity prompt 54 prompts a risk assessor to enter or assign a value representing a severity of the likely outcome of the hazard. For example, one hazard might present the risk of death. Another hazard might present the risk of hospitalization. Another hazard might only present the risk of a worker having to be administered with first aid.

As indicated by step 108, scoring module 40 directs processor 32 to generate control signals causing display 24 to present an occurrence probability prompt 56. Occurrence probability prompt 56 prompts a risk assessor to enter or assign a value representing the probability that the outcome of step 106 will occur for an individual exposure incident. For example, one hazard might have a very severe likely outcome, such as death, but the probability of the outcome may be extremely small. If the exposure to the hazard is large, the chance of the outcome occurring is higher. Alternatively, if the exposure to hazard is also small, the chance of the outcome occurring will remain small.

As indicated by block or step 110, scoring module 40 directs processor 32 to utilize each of the assigned exposure frequency, outcome severity an occurrence probability values to determine a risk based score. Unlike existing insurance premium drivers, the risk based score identified by system 22 is based upon predictive rather than historical values. For example, the risk based score is based upon exhibited exposure frequency to a hazard as well as a probability that an injury or damage from the exposure to the hazard will actually occur. As a result, the risk based score determined in step 110 by system 22 is better predicting the chance of injury or damage from a hazard as compared to the mere use of historical data.

As indicated by step 112, the risk based score determined in step 110 is utilized by system 20 to establish an insurance premium. Because each hazard is individually assigned to risk based score, individual hazards may be compared to one another to identify and prioritize precautionary actions to address the hazards. As shown by FIG. 1, the determined score 58 for the particular hazard is presented on display 24 by scoring module 40.

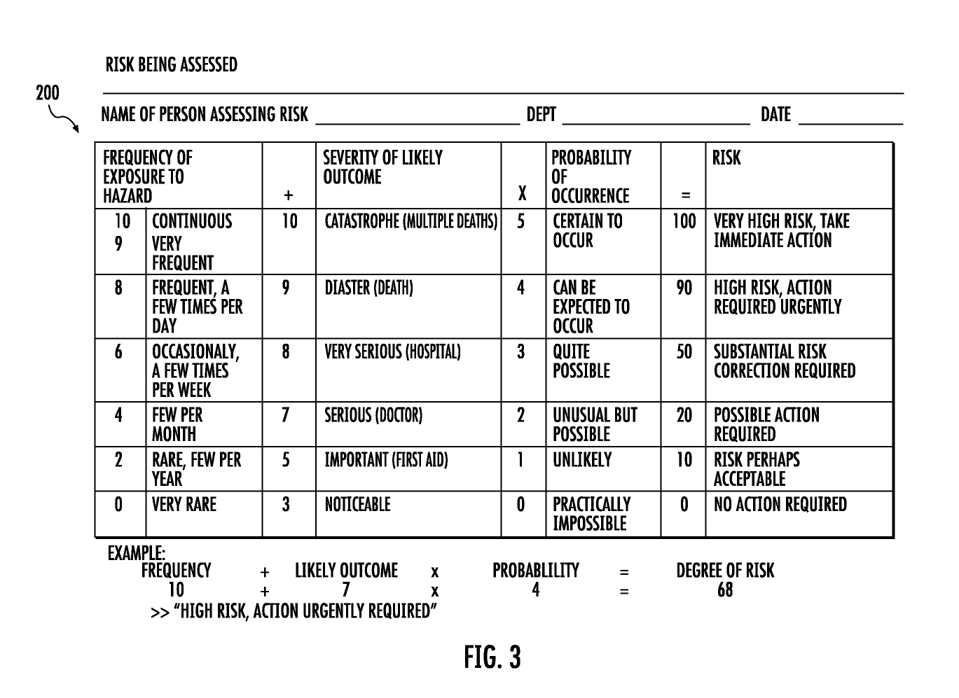

FIG. 3 illustrates an example matrix 200 for use when assigning the exposure frequency value, the outcome severity value and the occurrence probability value in steps 104, 106, and 108, respectively. FIG. 3 identifies one example that of categories and associated scales for each of the exposure frequency value, the outcome severity value and the occurrence probability value. In the example shown in FIG. 3, the risk assessor is prompted to enter an exposure frequency value based upon identification of the hazard belong to one of a plurality of frequency categories comprising: (1) “very rare” having a value of zero; (2) “rare, few per year” having a value of two; (3) “few per month” having a value of four; (4) “occasionally, a few times per week” having a value of six; (5) “frequent, a few times per day” having a value of eight; (6) “very frequent” having a value of nine; and (7) “continuous” having a value of 10. Likewise, in the example shown in FIG. 3, the risk assessor's prompt enter an outcome severity value based upon identification of the hazard having an outcome severity belonging to one of a plurality of outcome severity categories comprising: (1) “noticeable” having a value of zero; (2) “important (first aid)” having a value of one; (3) “serious (doctor)” having a value of 2, wherein a doctor visit may be warranted; (4) “very serious (hospital)”, requiring hospitalization, having a value of three; (5) “disaster (death)” resulting in death of the person exposed to the hazard and having a value of four; and (6) “catastrophe (multiple deaths)” wherein not only is the person exposed to the hazard likely to die, but collateral deaths of individuals around the person may also occur, having a value of five. In the example shown in FIG. 3, the risk assessor is prompted to enter or assign a value for occurrence probability to the identified hazard, the value selected from a group of occurrence probability categories comprising: (1) “practically impossible” having a value of zero; (2) “unlikely” having a value of one; (3) “unusual but possible” having a value of two; (4) “quite possible” having a value of three; (5) “can be expected to occur” having a value of four; and (6) “certain to occur” having a value of five. In another implementation, the scores may alternatively correspond to a percentage chance of occurrence.

In the example illustrated, system 20 determines a risk score for an individual hazard based upon a sum of the exposure frequency value and the outcome severity value multiplied by the occurrence probability value. As indicated in the final column of the matrix 200, the resulting score corresponds to a degree of risk and a corresponding prioritization indication for remedial or precautionary action. In the example illustrated, a risk score of zero corresponds to “no action required”, a risk score of or approaching 10 corresponds “risk perhaps acceptable”, the risk score of or approaching 20 corresponds to “possible action required”, risk score of or approaching 50 corresponds to “substantial risk, correction required”, risk of or approaching 90 indicates “high risk, action required urgently, while a risk score of or approaching 100 indicates “very high risk, take immediate action”.

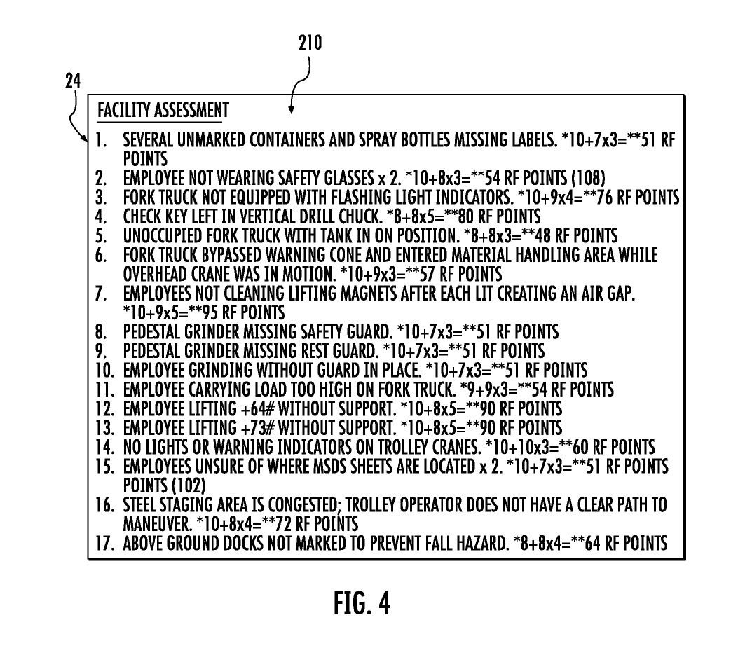

FIG. 4 illustrates an example output or listing 210 by device 22 upon completion of the risk assessment for a workplace, facility or site. The output presented in FIG. 4 may be displayed on display 24 by scoring module 40 or may be sent to a printer or other output device. In the example shown in FIG. 4, 17 hazards have been identified. Listing 210 is an itemized listing which indicates the exposure frequency value, the outcome severity value and the occurrence probability value for each hazard along with the determined risk or risk factor score. In other implementations, the risk factor score and the contributing risk factor values may be presented in other fashions.

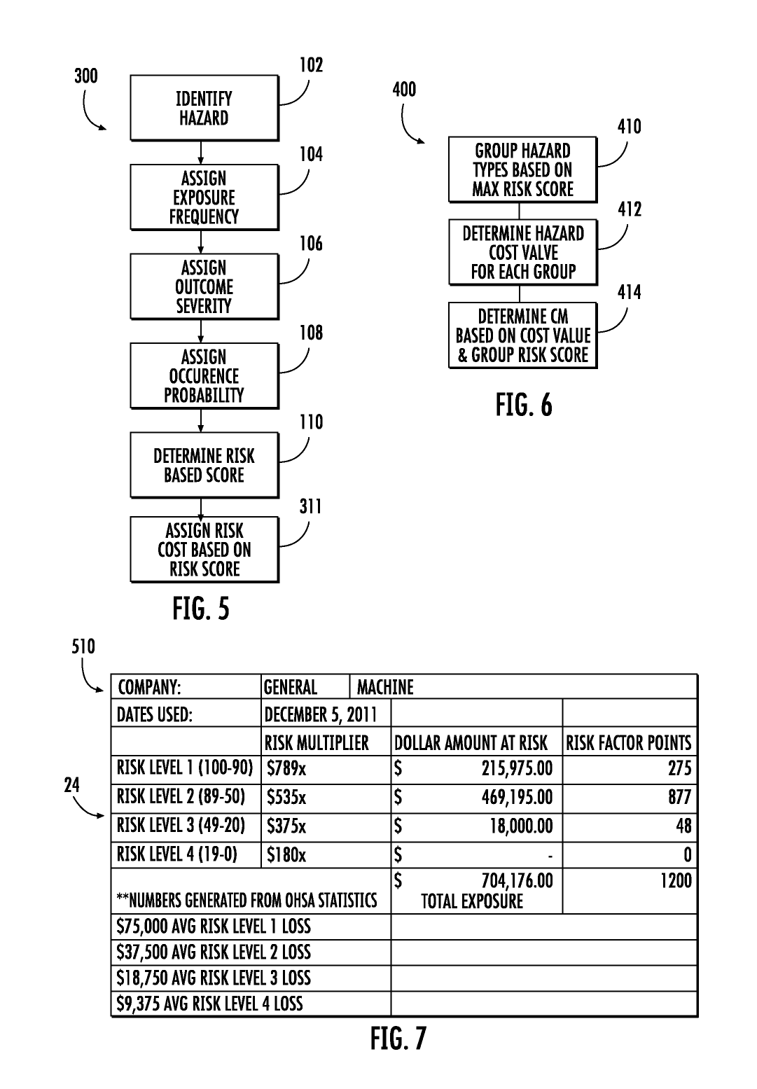

As shown by FIG. 1, in the example illustrated, system 20 further comprises risk cost module 42 in memory 34 in device 22. Risk cost module 42 comprises a module of computer readable programming or instructions, code, software or executable program configured to direct processor 32 to assign a risk cost to the identified hazard based upon the risk based score of the identified hazard. In the example illustrated, system 20 carries out method 300 shown in FIG. 5. Method 300 is similar to method 100 except that method 300 includes step 311 of assigning a risk cost which is based on the risk score. Those remaining steps of method 300 which correspond to steps of method 100 are numbered similarly. The risk cost determined in step 311 is a dollar value assigned to the risk of injury, damage or harm caused by the outcome of step 106 for the identified hazard taking place are occurring. The risk cost provides a better metric for evaluating exposure to a hazard and the need to take remedial or precautionary actions to address the hazard. In one implementation, risk cost module 42 multiplies the risk score (determined in step 110) by a risk cost multiplier.

As further shown by FIG. 1, risk cost module 42 accesses a database of cost multipliers 60 in memory 44. In addition or alternatively, risk cost module 42 may direct processor 32 to retrieve cost multipliers across a network 62 using transceiver 30. In the example illustrated, system 20 may further comprise a remote server 70 in communication with the vice 22 using a transceiver 72. Server 70 further comprises a processor 74 that may retrieve cost multipliers 60′ in a non-transitory memory 76. In one implementation, server 70 may comprise a cost multiplier module 78. Cost multiplier module 78 comprises a module of executable programming, computer-readable instructions, software or code configured to direct processor 74 to determine and store cost multipliers 60′ in memory 76 for use by one or more devices 22 out in the field. Cost multiplier module 78 to determine cost multipliers according to method 400 of FIG. 6.

FIG. 6 is a flow diagram illustrating method 400, one example of determining one or more cost multipliers for use in determining a risk cost based upon a risk score. As indicated by step 410, different hazard types are grouped together based upon the maximum risk score associated with a particular risk or hazard. For example, a first hazard may have a high maximum risk score due to the potential that an outcome might be the death of a person. In contrast, a second hazard may have a relatively low maximum risk score due to a low severity of the potential outcome. For example, the second hazard, at worst, may merely result in a person having to be administered with first aid.

As indicated by step 412, for each group of hazard types having similar maximum risk scores (similar outcome severity scores), a hazard cost value is determined. In one implementation, the hazard cost value assigned to each group may be an average of historical costs for such outcomes. In another implementation, the hazard cost value being assigned may be a median value of historical costs for such outcomes of those hazards in the group. In one implementation, the hazard cost value is determined from historical data gathered by one or more public agencies such as the Occupational Safety and Health Administration, the Department of Labor, and the United States Industrial Commission. In other implementations, other or additional governmental, community or public sources may be utilized as sources for the historical costs from which the hazard cost value for each group is determined. In one implementation, historical data from an individual company or entity for which the risk assessments performed may be utilized as a basis for determining hazard cost value for each hazard grouping.

In such implementations, cost multiplier module 78 direct processor 74 to retrieve such historical data across one or more wide area networks or local area networks utilizing transceiver 72. In one implementation, the historical cost values used to determine the hazard cost value for each hazard grouping is periodically updated. In one implementation, such updates are automatically completed on a periodic basis, such as every three years. In other implementations, such updates may occur in response to a manual triggering or request for such an update.

As indicated by step 414, the cost multiplier for each group is determined based upon the hazard cost value for the group and the risk score range for the group. In one implementation, cost multiplier module 78 directs processor 74 to divide hazard cost value for the group by the maximum risk score for the particular hazard grouping to identify the cost multiplier for each risk score point of the risk score for a particular hazard within the particular risk or hazard grouping. In another implementation, cost multiplier module 78 directs processor 74 to divide the hazard cost value for the group by the median risk or for the particular hazard grouping to identify the cost multiplier for each risk or point of the risk or for a particular hazard within the particular risk or hazard grouping. In another implementation, cost multiplier module 78 directs processor 74 to divide the hazard cost value for the group by the minimum risk door for the particular hazard grouping to identify the cost multiplier for each risk score point of the risk or for a particular hazard within the particular risk or hazard grouping. Once determined, cost multiplier module 78 directs processor 78 to store the value for the cost multiplier in storage 60″ of memory 76 and/or call to multiplier storage portion 60 of memory 44.

FIG. 7 illustrates an example output 510 which may be presented on display 24 of device 22 by risk cost module 42. In other implementations, output 510 may alternatively be presented on a remote display, such as on a website, or may be printed. In the example shown in FIG. 7, hazards or risks are divided and grouped into four different groupings based upon the maximum risk scores associated with the hazard types. As shown by the example in FIG. 7, hazards within risk level 4 have a maximum risk score of between zero and 19 and have a determined cost multiplier of $180. Hazards within risk level 3 have a maximum risk score of between 20 and 49 and have a determined cost multiplier of $375. Hazards within risk level 2 have a maximum risk score of between 50 and 89 and have a cost multiplier of $535. Lastly, hazards within risk level 1 have a maximum risk or of between 90 and 100 and have a cost multiplier of $789. As shown on the right side of FIG. 7, the risk factor scores for the various identified hazards in each of the hazard groupings are added together and multiplied by the corresponding risk multiplier to arrive at a risk cost for each group of the entity has a cost exposure of hazards. The total risk cost or exposure may be determined by adding together all of the risk costs for the hazards of the different hazard groupings. In the example illustrated, the workplace, company or site has a cost exposure of $216,975 for those hazards having a maximum risk or of between 90 and 100, risk hazards falling in a “very high risk” category in which immediate action should be taken (see FIG. 3). The entity has a cost exposure of $469,195 for hazards having a maximum risk score of between 50 and 89, risk hazards for which there is at least a substantial risk and for rich corrective action or precautionary measure should be taken. As indicated by output 510, the entity has a cost exposure of merely $18,000 for hazards having a maximum risk door of between zero and 19, hazards for which the risk is largely acceptable such that no action is needed. Best, output 510 provides a manager or decision-maker with a metric for identifying hazards and prioritizing precautionary or remedial action.

Although output 510 illustrate the use of one set of four hazard groupings, in other implementations, a greater or fewer of such hazard groupings may be utilized. In other implementations, additional sets of hazard groupings may also be utilized. For example, one set of different hazard groupings and associated cost/risk multipliers may be utilized for a first industry while a second different set of different hazard groupings and associated cost/risk multipliers may be utilized for a second industry different than the first industry. Different sets of different hazard groupings and associated cost/risk multipliers may be utilized for different geographic regions. For example, a first set of different hazard groupings and associated cost/risk multipliers may be utilized in one region of the country while second set of different hazard groupings and associated cost/risk multipliers may be utilized in a different region of the country. Different sets of different hazard groupings and associated cost multipliers may be utilized based upon different characteristics or factors.

As shown by FIG. 1, scoring module 40 and risk cost module 42 direct processor 32 to store the determined risk scores and risk costs (such as list 210 and output 510) in storage portion 80 of memory 44. In one implementation, such risk scores and risk costs a further be uploaded and stored in storage portion 82 of memory 76, providing remote access to such information. In the example illustrated, device 22 is illustrated as comprising scoring module 40 and risk cost module 42 such that the determination of risk scores and risk costs are locally performed on device 22. In other implementations, such determinations may be made remotely such as that server 70. For example, in one implementation, server 70 may comprise scoring module 84 and risk cost module 86. In such an implementation, scoring module 84 directs processor 74 to retrieve the acquired hazard identification, exposure frequency value, outcome severity value and occurrence probability value for each hazard. Scoring module 84 further directs processor 74 to determine and store the risk score for each hazard. In one implementation, scoring module 84 may direct processor 74 to transmit the risk scores via transceiver 72 to device 22 for display. Utilizing the risk scores, risk cost module 86 determines the risk cost of each hazard and the cumulative risk cost or exposure for the particular site being assessed. Such risk cost may further be stored in storage portion 82 and may also be transmitted to device 22 for display. By performing such determinations at server 72, rather than locally at device 22, the processing power consumption a device 22 may be reduced, lowering the cost of device 22. Moreover, updates may be more easily implemented at server 70 for multiple devices 22 of system 20.

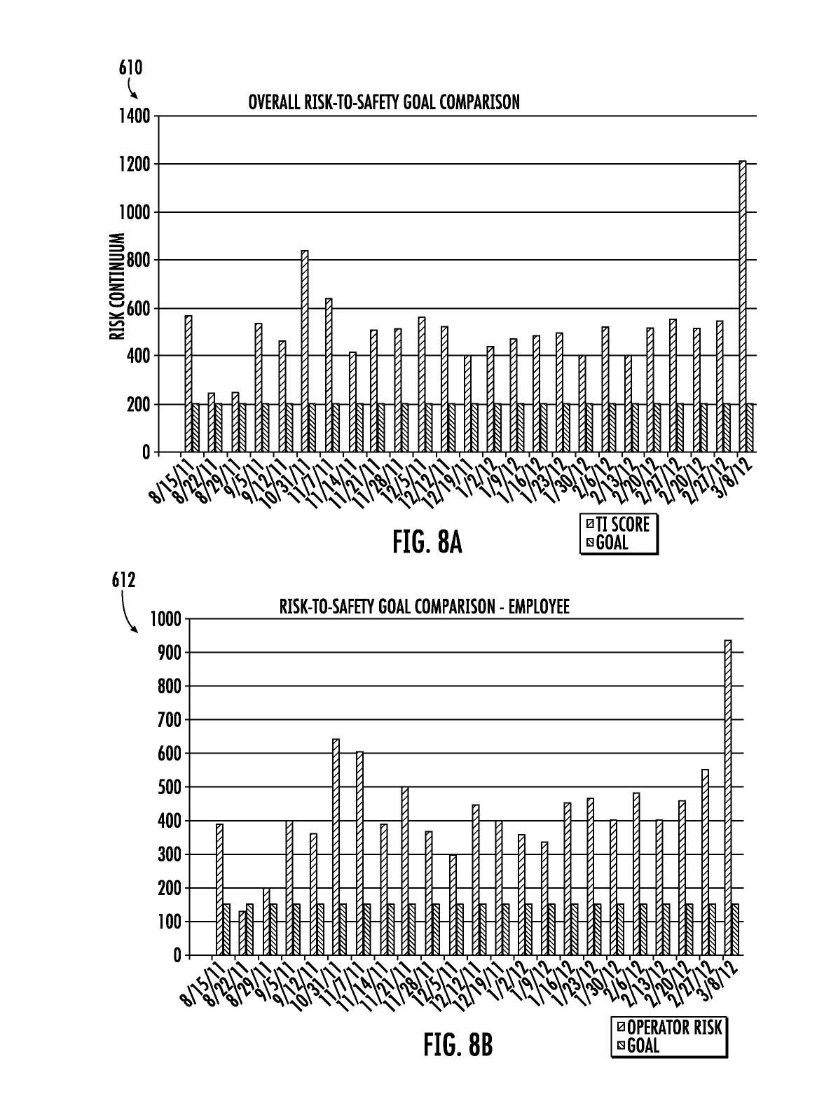

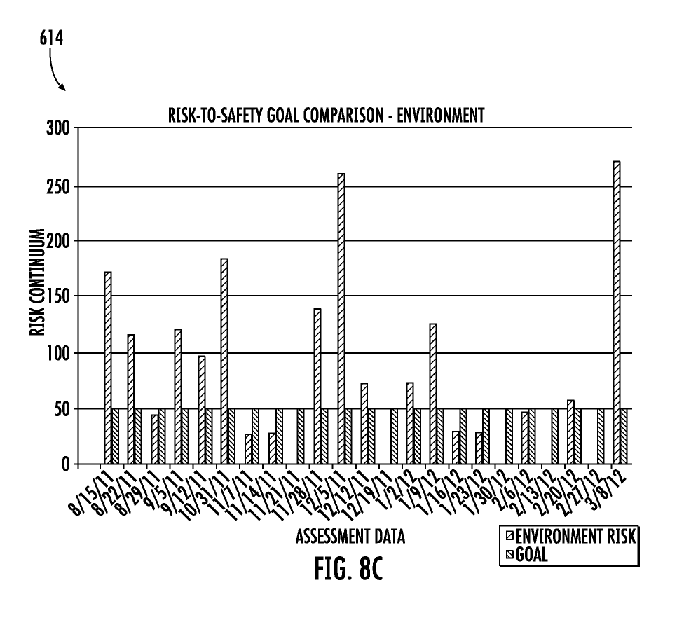

FIGS. 8a-8c illustrate examples of outputs 610, 612 and 614, respectively, that may be presented on display 24 or display associated with a remote server 70, such as on a website. Outputs 610, 612 and 614 facilitate a comparison of the risk scores for the particular workplace or site being assessed to risk scores of other entities or other workplaces. To facilitate such comparisons, processor 74, following instructions contained in memory 76, determines risk scores for other entities utilizing publicly available information for hazard costs for such other entities. In one implementation, processor 74 retrieves accident incident statistics for other entities from such sources across a wide area network or through manual input. Examples of such sources include OSHA, the Department of Labor and the Industrial Commission. Utilizing the same scoring system employed to determine risk scores for the company or site being assessed, such as matrix 200 in FIG. 3, server 70 determines a corresponding risk score for others in the corresponding industry of the workplace being assessed. In such determinations, the risk or of the other entities is determined based upon a probability of occurrence of 5 (the reported incidents are incidents that actually occurred). The outcome severity value is taken directly from the public a reported cost for the incident. The frequency of exposure is determined based upon the number of incidents are accidents that actually occurred during measured time period. For example, if a public report indicates that an average of 100 accidents occurred during a year for an individual company, the frequency of exposure would have a value of 6 (a few per week; 100÷52). As shown by FIG. 8A, the risk score for the entity may be directly compared to other entities in the same industry. As shown by FIG. 8A, the number of employees for the entity and the number of employees for others in the industry may be taken to account to evaluate the risk score taken account the number of employees. As indicated by FIG. 8c, such risk assessment may further be performed to identify not only risks to individuals or persons, but risks to the environment. In such instances, the same methods are utilized except that the risk or damage is injury to the environment and the severity outcome is dependent upon the dollar cost to remediate such environmental damage (environment of cleanup).

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
identifying hazards;
assigning an exposure frequency value to each identified hazard;
assigning an outcome severity value for each identified hazard;
assigning an occurrence probability value for each identified hazard;
determining, with a computing device, a risk-based score for each identified hazard based on the exposure frequency value, the outcome severity value and the occurrence probability value of each of the identified hazards; and
establishing an insurance premium based on the risk based score.

2. The method of claim 1, wherein the risk factor is determined based upon the sum of the exposure frequency value and the outcome severity value multiplied by the occurrence probability value for each identified hazard.

3. The method of claim 1 further comprising assigning a risk cost based upon the risk-based score.

4. The method of claim 3, wherein the risk cost is assigned based upon the risk-based score and one of a plurality of cost multipliers selected based upon the risk-based score.

5. The method of claim 4, wherein the plurality of cost multipliers are assigned to a plurality of corresponding risk-based score ranges, wherein said one of the plurality of cost multipliers selected based upon which of the risk-based score ranges in which the risk-based score falls.

6. The method of claim 1 further comprising outputting an itemized listing for each identified hazard, the itemized listing indicating the exposure frequency value, the outcome severity value and the occurrence probability value for each hazard.

7. An apparatus comprising:
a non-transitory computer-readable storage medium with an executable program stored thereon, when the program instructs a processing unit to perform the following steps:
prompting for input of and receiving hazards;
prompting for input of an receiving an exposure frequency value for each received hazard;
prompting for input of an receiving an outcome severity value for each received hazard;
prompting for input of an receiving an occurrence probability value for each identified hazard;
determining a risk-based score for the workplace based on the exposure frequency value, the outcome severity value and the occurrence probability value of each of the identified hazards.

8. The apparatus of claim 6, wherein the risk factor is determined based upon the sum of the exposure frequency value and the outcome severity value multiplied by the occurrence probability value for each identified hazard.

9. The apparatus of claim 6, wherein the program instructs the processing unit to further assign a risk cost based upon the risk-based score.

10. The apparatus of claim 6, wherein the program instructs the processing unit to further output an itemized listing for each identified hazard, the itemized listing indicating the exposure frequency value, the outcome severity value and the occurrence probability value for each hazard.

11. The apparatus of claim 7, wherein the outcome severity value is based upon an identification of the hazard belonged to one of a plurality of outcome categories comprising death, hospitalization, doctor and first aid.

12. The apparatus of claim 7, wherein the exposure frequency value is based upon an identification of the hazard belonging to one of a plurality of frequency categories comprising a few times per year, a few times per month, a few times per week, and a few times per day.

13. A machine for evaluating workplace risk, comprising:
a processing unit coupled to a memory,
wherein the processing unit is programmed to evaluate risk by:
prompting for input of and receiving hazards;
receiving an exposure frequency value for each received hazard;
receiving an outcome severity value for each received hazard;
receiving an occurrence probability value for each identified hazard;
determining a risk-based score for the workplace based on the exposure frequency value, the outcome severity value and the occurrence probability value of each of the identified hazards.

14. The machine of claim 13, wherein the risk factor is determined based upon the sum of the exposure frequency value and the outcome severity value multiplied by the occurrence probability value for each identified hazard.

15. The machine of claim 13, wherein the processing unit is further programmed to assign a risk cost based upon the risk-based score.

16. The machine of claim 13, wherein the processing unit is further programmed to output an itemized listing for each identified hazard, the itemized listing indicating the exposure frequency value, the outcome severity value and the occurrence probability value for each hazard.
